(19) United States
(12) Patent Application Publication
(10) Pub. No.: US 2026/0301664 A1
(43) Pub. Date: Oct. 1, 2026

(54) DISPLAY EDGE DIMMING FOR A GPU DISPLAY ENGINE

(71) Applicants: Tamoghna Ghosh, Bangalore North (IN); Susanta Bhattacharjee, Bangalore (IN); Geethacharan Rajagopalan, Gold River, CA (US)

(72) Inventors: Tamoghna Ghosh, Bangalore North (IN); Susanta Bhattacharjee, Bangalore (IN); Geethacharan Rajagopalan, Gold River, CA (US)

(73) Assignee: Intel Corporation, Santa Clara, CA (US)

(21) Appl. No.: 19/094,086

(22) Filed: Mar. 28, 2025

(51) Int. Cl. G09G 3/3208; G06T 5/73; G06T 7/11; G06T 7/12

(52) U.S. Cl. CPC G09G 3/3208; G06T 5/73; G06T 7/11; G06T 7/12; G06T 2207/20104; G06T 2207/20164; G09G 2320/02; G09G 2330/023; G09G 2360/16

(57) ABSTRACT

Systems and techniques for adaptive dimming for a display are disclosed herein. An area of interest is obtained for pixels displayed on the display. A dimming factor is calculated for a pixel of the pixels based on a distance of the pixel from a center of the area of interest. Display input is received to be output on the display. Display output is generated by applying the dimming factor to the display input.

### BACKGROUND

Organic Light-Emitting Diode (OLED) displays may utilize edge dimming as a standard method for display power saving. Edge dimming is a technique employed by several display manufacturers. Edge dimming is activated in Direct Current (DC) power mode to maintain pixel brightness within a central rectangle of a display while gradually dimming pixels towards the edges, achieving an 8-10% reduction in display power consumption. This design leverages an observation that user focus typically remains near the center of the screen during personal computer use and during media consumption. However, the implementation of edge dimming varies significantly among display vendors in terms of dimming intensity, smoothness of transition, and activation conditions, leading to inconsistent user experience and increased validation efforts.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of a system for adaptive edge dimming, according to an embodiment.

FIG. 2 illustrates a pixel dimming factor outside an area of interest for adaptive edge dimming, according to an embodiment.

FIG. 3 illustrates circular contours of equidistant pixels from the center of an area of interest for adaptive edge dimming, according to an embodiment.

FIG. 4 illustrates a rounded rectangle profile for adaptive edge dimming, according to an embodiment.

FIG. 5 illustrates a rounded rectangle dimming effect with small, rounded corners for adaptive edge dimming, according to an embodiment.

FIG. 6 illustrates a contour plot for adaptive edge dimming, according to an embodiment.

FIGS. 7A and 7B illustrate plots of a function for higher power changing according to an embodiment.

FIGS. 8A and 8B are screenshots of application of adaptive edge dimming in a chat application, according to an embodiment.

FIGS. 9A and 9B are screenshots of application of adaptive edge dimming in a spreadsheet application, according to an embodiment.

FIGS. 10A and 10B are screenshots of application of adaptive edge dimming in a video conference application, according to an embodiment.

FIGS. 11A and 11B are screenshots of application of adaptive edge dimming in a word processing application, according to an embodiment.

FIG. 12 is a flow chart of an example of a process for adaptive edge dimming, according to an embodiment.

FIG. 13 is a flow chart of an example of a method for adaptive edge dimming, according to an embodiment.

FIG. 14 is a block diagram illustrating an example of a machine upon which one or more embodiments may be implemented.

### DETAILED DESCRIPTION

The static nature of current edge dimming, which involves a fixed boundary margin of the display being dimmed, presents challenges in certain usage scenarios. For instance, a user may type in a chat where the chat text box is at the bottom of the screen or use a productivity application like a spreadsheet application where the user is analyzing data columns or rows close to the edges of the screen. In these instances, conventional edge dimming may result in dimmed areas that hinder visibility. Fixed edge dimming may be perceived by the user as a display defect, leading a computing device manufacturer to disable the edge dimming feature. Consequently, the absence or disabling of edge dimming in displays results in missed opportunities for power savings. Some display timing controllers (TCONs) include the edge dimming solution. However, the dimming strength and dimming rectangle are fixed and not directly configurable in software and edge dimming may occur outside a fixed rectangular area on the display. Edge dimming is applied/withdrawn sharply when the feature is activated/deactivated leading to a poor user experience. A manufacturer may desire to make edge dimming adaptive allowing the dimming margin to be chosen based on usage scenarios.

The issues associated with fixed margin edge dimming are addressed by employing adaptive edge dimming that enables the dimming margin to be chosen based on usage scenarios. Adaptive edge dimming may be integrated into display engine (DE) hardware to ensure consistency across displays. The adaptive dimming approach discussed herein smoothly adjusts edge dimming based on current usage scenarios and integrates adaptive edge dimming efficiently within the DE hardware without introducing visual artifacts. This approach reduces artifacts, allows for uniform implementation among different vendors, ensures a consistent user experience, and enhances power efficiency across all organic light-emitting diode (OLED) displays.

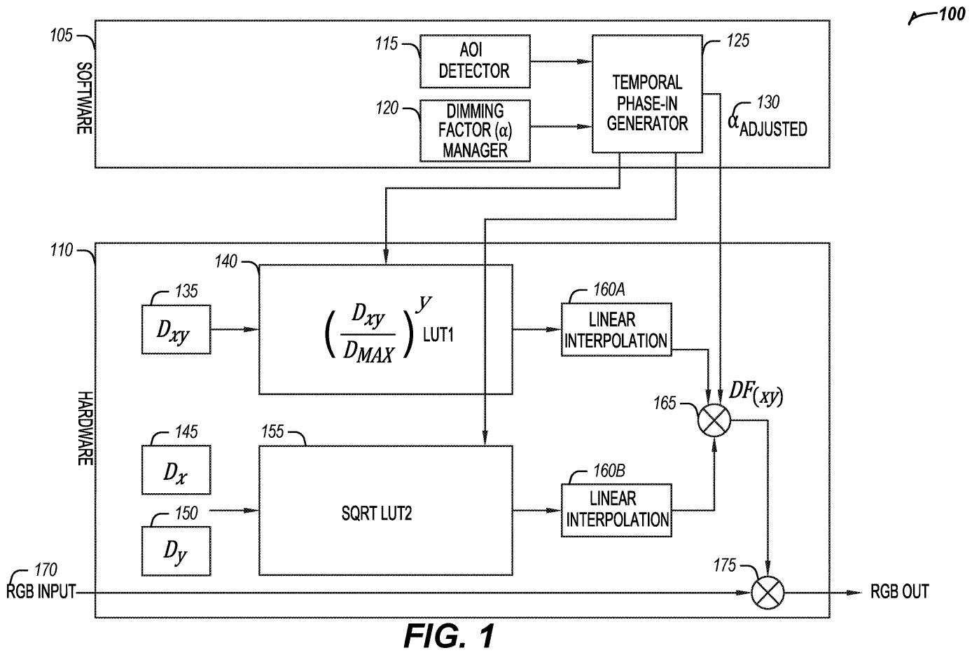

FIG. 1 is a block diagram of an example of a system 100 for adaptive edge dimming, according to an embodiment. The system 100 includes software components 105 including a dimming factor manager 120, an Area of Interest (AOI) detector 115, and a temporal phase-in generator 125. The AOI detector 115 may be an object detection module that identifies text/person. The dimming factor manager 120 determines a dimming factor α dynamically and adjusts the dimming factor based on a current battery charge level, based on display content analysis, etc. An edge dimming effect is gradually enabled/disabled when adaptive edge dimming is enabled by further controlling the α value using an exponential moving average based temporal phase-in filter (α_{adjusted}) 130 calculated by the temporal phase-in generator 125. The temporal phase-in filter is an input to core dimming computation logic in display hardware 110.

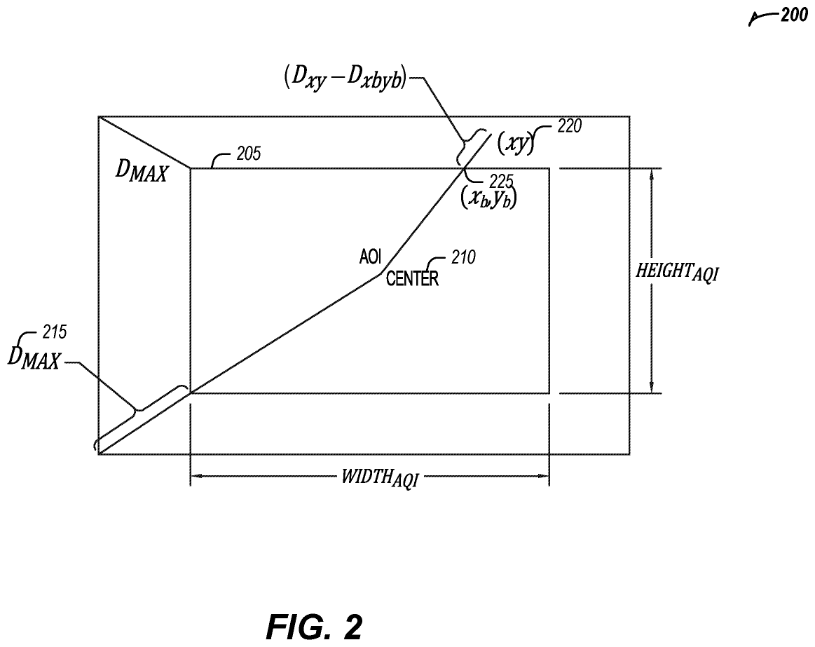

As shown in FIG. 2, a metric is used to compute a pixel distance from a center 210 of an AOI 205. The metric is computed efficiently where a distance of corners of a display 200 from AOI 205 corners are denoted as D_{Max} 215. This is a maximum possible pixel distance in the display 200 from the center 210 of the AOI 205. The distance of any pixel (x,y) 220 from the center 210 of the AOI 205 is denoted as D_{xy}. If the maximum allowed dimming of any pixel defined by αϵ(0,1), a pixel falling on a line connecting center 210 of AOI 205 to pixel (x,y) 220 which intersects the nearest AOI 205 edge is denoted as (x_{b},y_{b}) 225 and D_{xbyb} is the distance of (x_{b},y_{b}) 230 from the center 210. A pixel dimming factor outside the AOI 205 is calculated by a dimming factor calculator (e.g. dimming factor calculator 165 as described in FIG. 1, etc.) using formula

$$Dimming Factor DF ( x , y ) = \frac{{D}_{x y} - {D}_{x b y x}}{{D}_{Max}} α$$

as shown in FIG. 2.

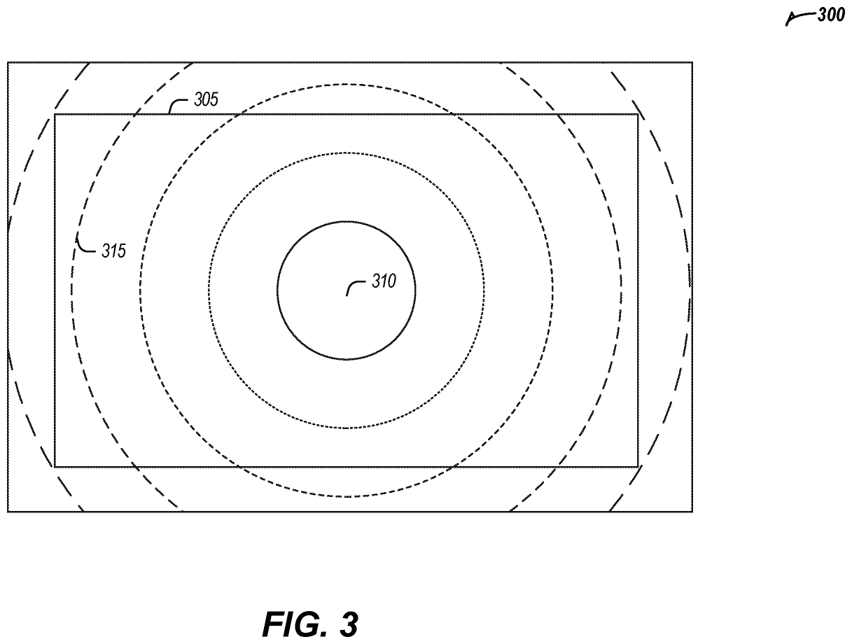

As shown in FIG. 3, using standard Euclidian distance creates circular contours 315 of equidistant pixels from the center 310 of the AOI 305. Hence, if the pixels are dimmed proportionally to Euclidian Distance from the center 310, a circular edge dimming effect is created rather than a desired rectangular edge dimming effect. A rectangular edge dimming effect is created for the area of interest 305 of the display 300 using a metric calculated to produce rectangular contours. However, sharp corners of rectangular contours introduce artifacts along diagonals of the display 300.

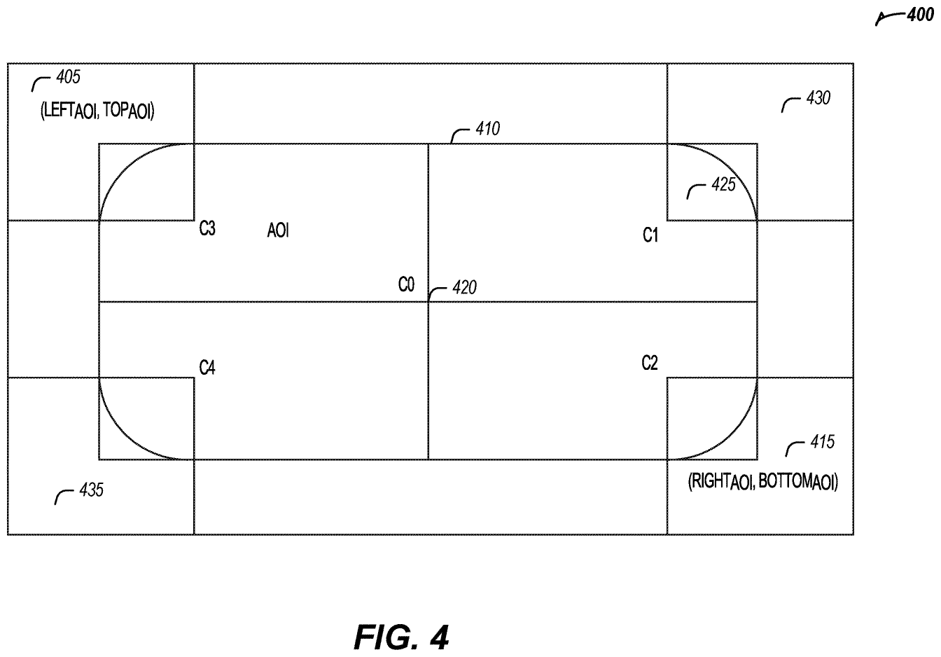

Using a circular or elliptic diming profile does not produce artifacts. However, the circular or elliptical dimming profile does not look visually appealing on a rectangular display. Thus, a new metric is used to produce a rounded rectangle such as the contours shown in FIG. 4. As shown in FIG. 4, (Left_{AOI},Top_{AOI}) 405 are coordinates of a top left corner of the AOI 410 and (Bottom_{AOI},Right_{AOI}) 415 are coordinates of a bottom right corner of the AOI 410 with respect to an origin C0 420 at the center of a frame 400. The coordinates of corner C1 425 with the origin at C0 420 are denoted as (c₁ₓ,c_{1y}). This is a first quadrant of the coordinate system and c₁ₓ>0,c_{1y}>0 and m=

$$Min ( \frac{{Height}_{A O I}}{4} , \frac{{Width}_{A O I}}{4} ) , {c}_{1 x} = {Right}_{{AOI}^{- m}} , {c}_{1 y} = {Top}_{{AOI}^{- m}} .$$

A pixel (x,y) falls in the top right corner 430 of FIG. 4 if x>c₁ₓ and y>c_{1y}. The symmetry of FIG. 4 and the origin being at C0 420, for any pixel (x,y) falling in any of the four boxes 405, 415, 430, and 435, the following inequality is true |x|>c₁ₓ, |y|>c_{1y}. The metric is defined as:

$${D}_{x y} = \{ \begin{matrix}( \sqrt[2]{{( \vert x \vert - {c}_{1 x} )}^{2} + {( \vert y \vert - {c}_{1 y} )}^{2} )} , & if \vert x \vert \geq {c}_{1 x} and \vert y \vert \geq {c}_{1 y} \\ \vert x \vert - {c}_{1 x} , & if \vert x \vert \geq {c}_{1 x} and \vert y \vert \leq {c}_{1 y} \\ \vert y \vert - {c}_{1 y} & if \vert x \vert \leq {c}_{1 x} and \vert y \vert \geq {c}_{1 y} \\ 0 , & otherwise\end{matrix} .$$

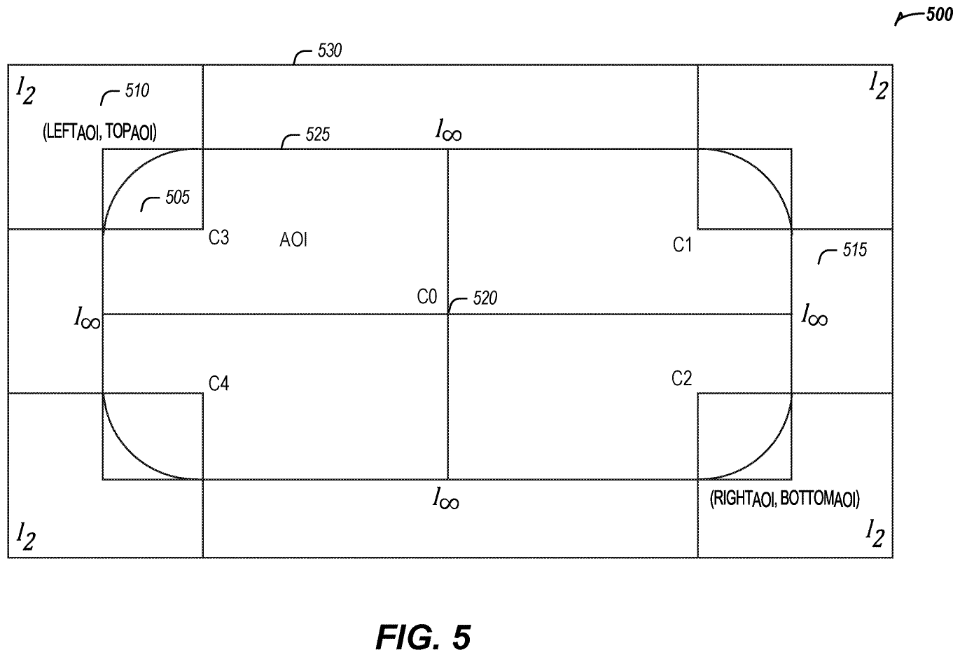

FIG. 5 illustrates a rounded rectangle 500 dimming effect with small, rounded corners 505 for adaptive edge dimming, according to an embodiment. The rounded rectangle contours may be created by using a metric as discussed in FIG. 5. Euclidian distance is derived from an ι₂ 510 norm. The formula for ι₂ 510 norm of a vector x is

$${‖ x ‖}_{2} = \sqrt[2]{{\sum }_{i} {x}_{i}^{2}} .$$

A norm implies a distance,

$$d ( x , y ) = {‖ x - y ‖}_{2} = \sqrt[2]{{\sum }_{i} {( {x}_{i} - {y}_{i} )}^{2}} = Euclidean Distance .$$

The mathematical generalization of ι₂ 510 norm is ιₚ norm

$${‖ x ‖}_{p} = \sqrt[p]{{\sum }_{i} {x}_{i}^{p}} .$$

The distance with respect to ιₚ norm is computed as

$$d ( x , y ) = {‖ x - y ‖}_{p} = \sqrt[p]{{\sum }_{i} {( {x}_{i} - {y}_{i} )}^{p}} p > 0 .$$

As p→∞ the norm is simplified and is defined as

$$d ( x , y ) = {‖ x - y ‖}_{∞} = {max}_{i} \vert {x}_{i} - {y}_{i} \vert .$$

The ι_{∞} 515 norm is used to compute pixel distance from center 520 of an AOT 525. Computationally ι_{∞} 515 norm is less resource intensive to calculate than other values of ιₚ because the only computation is a max computation of the pixel coordinate difference from center 520 of the AOI 525. Other ιₚ norms use p^{th} power computation and 1/p^{th} power or p^{th} power root. A problem of using the ι_{∞} 515 norm is sharp corners of the contour. Along the diagonal the gradient of the contour changes direction, and a line artifact may be seen along the diagonal. The line artifact may create a negative visual experience. The AOI 525 created by a p-norm is symmetric in shape in two dimensions resulting in generation of a circle, a square, or a rounded corner square shape. This symmetric shape may be changed to rectangular by using a weighted p-norm with the aspect ratio

$$( {a}_{r} = \frac{Width}{Height} )$$

of a display 530 as a weight in equation

$${‖ x ‖}_{p , w} = \sqrt[p]{{\sum }_{i} {w}_{i} {x}_{i}^{p}} , 0 < {w}_{i} < ∞ .$$

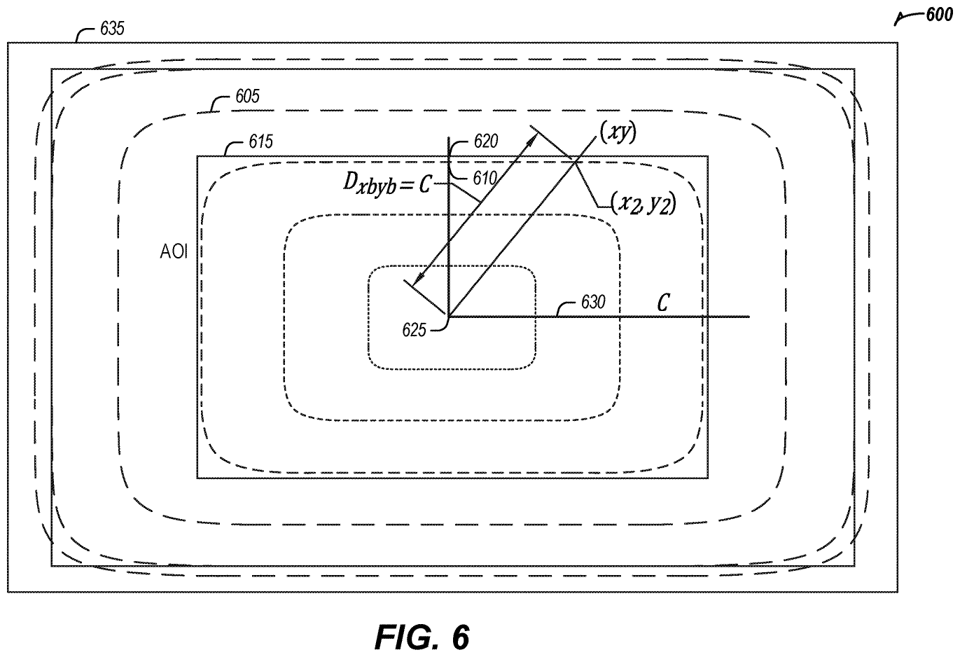

FIG. 6 illustrates a contour plot 600 for a weighted p norm for adaptive edge dimming, according to an embodiment. In FIG. 6, p-norm has w₁=1 and w₂=(aᵣ)^{p}. The contours 605 ease computation of distance D_{xbyb} 610 in the dimming factor calculation because it is constant on the contour line as shown in FIG. 6. Thus, the resulting dimming factor equation is

$$Dimming Factor DF ( x , y ) = \frac{{D}_{x y} - C}{{D}_{Max}} α .$$

The value of C 630 is computed by putting the coordinates of mid-points of the top side 620 of the AOI 615, which is just above the center 625 and the coordinates are

$$( 0 , \frac{{Height}_{A O I}}{2} ) .$$

At this point, the value of ιₚ norm is

$$C = ( {a}_{r} * \frac{{Height}_{A O I}}{2} ) .$$

D_{Max} is computed by subtracting C 630 from the norm of any of the corners of the frame 635 as shown in the equation:

$${D}_{Max} = \sqrt[p]{{( \frac{{Width}_{f r a m e}}{2} )}^{p} + {{a}_{r}^{p} ( \frac{{Height}_{f r a m e}}{2} )}^{p}} - C .$$

Within the rounded rectangle the distance is 0 and outside the rounded rectangle the distance is given by the metric equation. The metric simplifies calculation of the dimming factor by eliminating the need to compute D_{xbyb} as it is 0. So, a revised dimming factor is calculated as

$$D F ( x , y ) = \frac{{D}_{x y}}{{D}_{Max}} α .$$

The dimming equation makes the boundary of the AOI 625 visible. An improvisation such as

$$D F ( x , y ) = {( \frac{{D}_{x y}}{{D}_{Max}} )}^{γ} α$$

prevents visibility of the boundary. Where γ is a constant chosen through experimentation. For example, 1.5≤γ≤2.0 may provide visual smoothness and power saving. Lowering γ makes the boundary of the AOI 625 visible while increasing y reduces power savings.

Returning to the description of FIG. 1, the improvised equation involves calculation of power, square root, and division. For larger resolutions like a display resolution of 4000 horizontal lines (4K), the improvised equations may have to manage very large numbers while measuring pixel distance from the AOI center to the display corners. Dimming factor calculation may be completed in real-time by hardware 110, however, to reduce processing resource utilization, values may be pre-calculated and stored to reduce real-time calculations. In an example, lookup tables (LUTs) may store the calculated values. A full lookup table (LUT) that manages possible inputs is not feasible to implement in hardware 110. Therefore, two sampled LUTs are used to simplify the calculations. Because the LUTs do not have samples for all possible inputs, linear interpolation is used while calculating output of a LUT for a given input value.

D_{xy} 135 is input into the hardware 110 processor using LUT1 140. D_{Max} is constant for a given AOI output by the AOI detector 115 and a given display resolution. Hence

$${( \frac{{D}_{x y}}{{D}_{Max}} )}^{γ}$$

is converted to a LUT1 145 in which the index of the LUT1 140 is proportional to D_{xy} 135. For example, a LUT1 140 with 129×16 bit samples may be sufficient for display resolution up to 4K.

Dₓ 145 and D_{y} 150 are input into the hardware 110 processor using LUT2 155. If needed, a square root is calculated using LUT2 155 with 257×16 bit samples. Linear interpolation 160A and 160B is applied to LUT1 140 and LUT2 155. For example, for linear interpolation 160B applied to LUT2 155, D_{xy}=LinearInterpolate(LUT2, Dₓ*Dₓ+D_{y}*D_{y}. Where D_{xy} is calculated using the metric calculation equation. Linear interpolation 160A is applied to LUT1 140 to calculate the dimming factor DF(x,y) 165. If D_{xy} is not zero, DF(x,y)=α*LinearInterpolate(LUT1, D_{xy}), else DF(x,y)=1.

Red, Green, and Blue (RGB) components 170 of the pixels are scaled down using the dimming factor 165. For example, the RGB outputs 175 are calculated as, Rₒᵤₜ=DF(x,y)*Rᵢₙ, Gₒᵤₜ=DF(x,y)*Gᵢₙ, and Bₒᵤₜ=DF(x,y)*Bᵢₙ. There might be slight color banding with images having smooth spatial gradient of brightness. The slight color banding is suppressed by enabling dithering in display engine hardware. Banding happens with a variety of pixel processing algorithms, and this is not a problem specific to adaptive edge dimming.

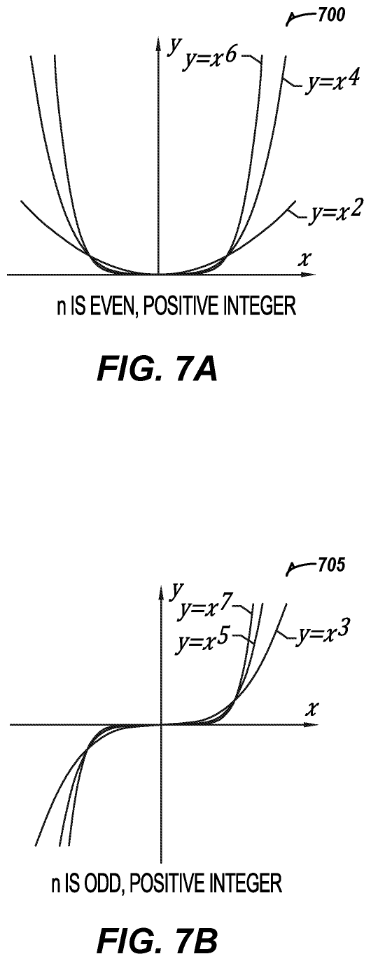

A computational cost of weighted p-norm is computed using p^{th} root and p^{th} power where p≥6. This is computationally costly and is approximated by implementing these two as two precomputed LUTs one for p^{th} root (LUT2 155) and another for p^{th} power (LUT1 140). However, these LUT sizes may be big as the function for higher power changes slowly in the lower range and then suddenly starts increasing at a very fast speed as shown in FIG. 7A where a graph 700 illustrates curves when n is an even positive integer and FIG. 7B where a graph 705 illustrates curves when n is an odd positive integer.

An approximation approach at the corners of AOI that use ι₂ and otherwise use ι_{∞} to leverage the simplicity of the of the ι_{∞} norm and smoothness ιₚ (p>1) norms. This results in a rounded rectangle dimming effect with small, rounded corners as shown in FIG. 5. This is implemented by using one LUT (LUT2 155) for approximating the square root function used in the ι₂ norm.

Conventional display TCON solutions apply dimming instantaneously upon activation/deactivation of the feature. Often, such activation is triggered automatically when a laptop goes to battery powered mode. Deactivation happens when the laptop is plugged back. Instantaneous dimming of pixels with such automatic trigger causes a poor user experience.

A phase-in approach of the dimmed region and/or dimming strength is enabled through a temporal smoothening filter applied by the temporal phase-in generator 125. An Infinite impulse response (IIR) filter equation causes transition of a variable Yₙ to Y_{target} over few iterations as Yₙ=(1−Beta)*Yₙ₋₁+Beta*Y_{target}. The speed of transition depends on Beta. Beta ranges in [0, 1] and increasing beta increases speed of transition. A value of beta is determined by a required speed of transition and how frequently each iteration is executed. For example, a phase-in triggered by the software component 105 may have a thirty millisecond (ms) period for each iteration. A beta value 0.25 creates seventy-four steps to complete transition of Y from 0 to 1. That takes about 2.2 seconds to complete the phase-in at the rate of 30 ms per step. Coordinates of the dimmed rectangle and the dimming strength alpha can be smoothened using the improvised dimming equation while activating/deactivating dimming.

For example, when activation dimming from an undimmed state, initial coordinates of the dimmed rectangle are equal to display resolution. For example, for a display with 2880×1800 resolution, the dimming rectangle is [(0, 0), (2880, 1800)]. The four coordinates of the rectangle are processed using the phase-in equation to reach to a target dimmed rectangle. Dimming strength α in the improvised dimming equation uses similar filtering as the phase-in equation, with an initial value of 0 (e.g., no dimming) to final desired value as target.

For example, when deactivating dimming to an undimmed state, coordinates of the dimmed rectangle are used as an initial value in the phase-in equations and the final target value is [(0, 0), (2880, 1800)]. The dimming strength α from the improvised dimming equation uses similar filtering as the phase-in equation, with the initial value as currently used to a value of 0 (e.g., no dimming) as target.

When changing a dimming rectangle and/or dimming strength, the IIR filter handles changing the Y_{target} while the current phase-in is not yet completed using the phase-in calculation. Hence, the size/position of dimming rectangle and/or dimming strength may be changed at any time. Rectangle coordinates and dimming strength α are processed using the phase-in equation during the change. Current rectangle coordinates and α are used as initial values and new rectangle coordinates and a are used as target values.

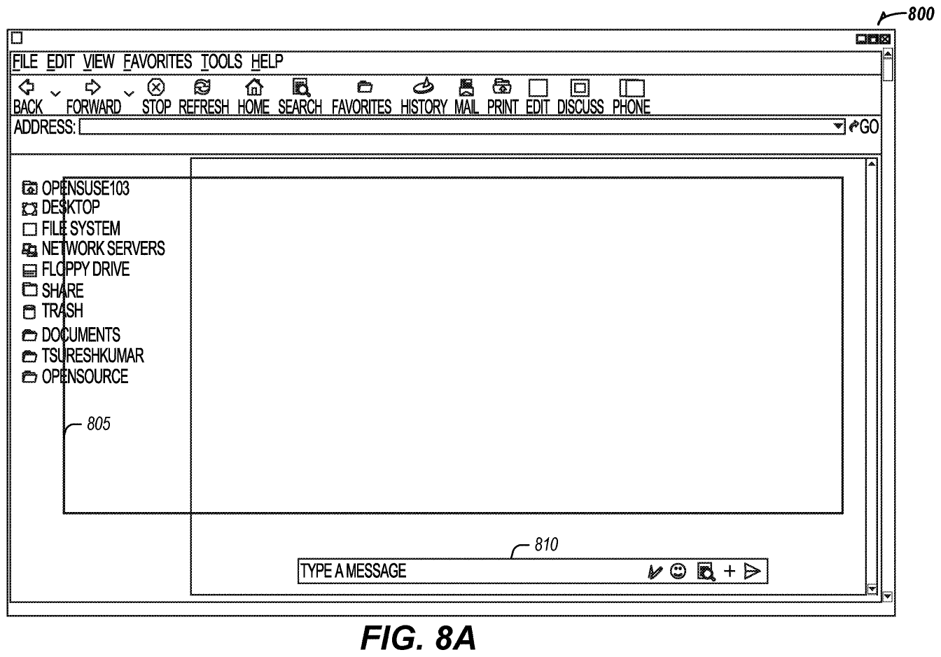

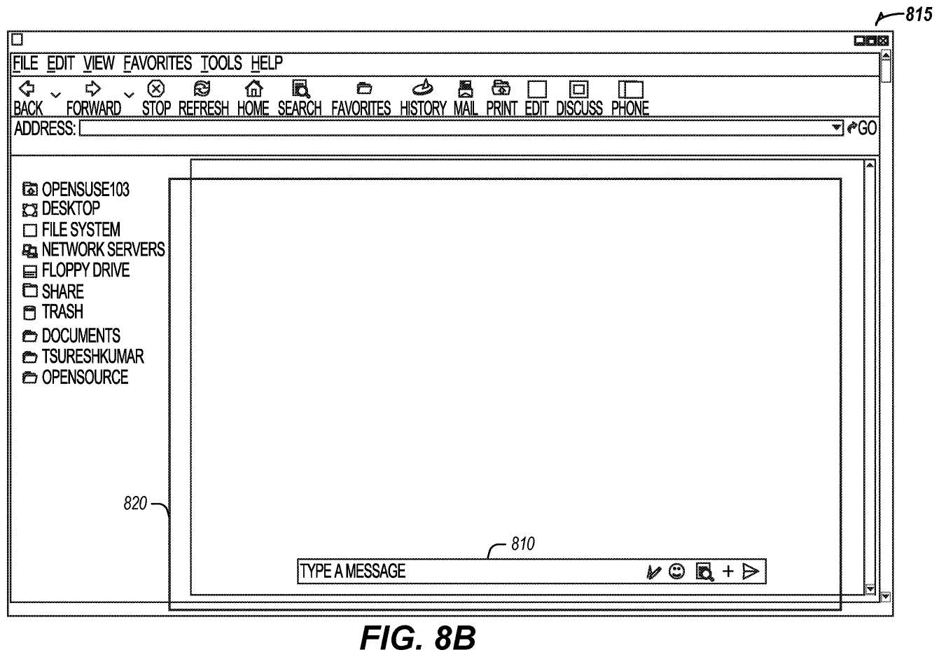

FIG. 8A, illustrates application of a conventional edge dimming boundary 805 based on conventional static dimming 800 for a chat window. The conventional edge dimming boundary 805 dims an input box 810 of the chat window obscuring a view of a user. FIG. 8B illustrates application of an adaptive dimming boundary 820 calculated using adaptive edge dimming 815 to the chat window rather than the conventional edge dimming boundary 805 as shown in FIG. 8A. As shown in FIG. 8B, application of the adaptive edge dimming boundary 820 prevents dimming of the chat box 810 while dimming edges where there is no activity present.

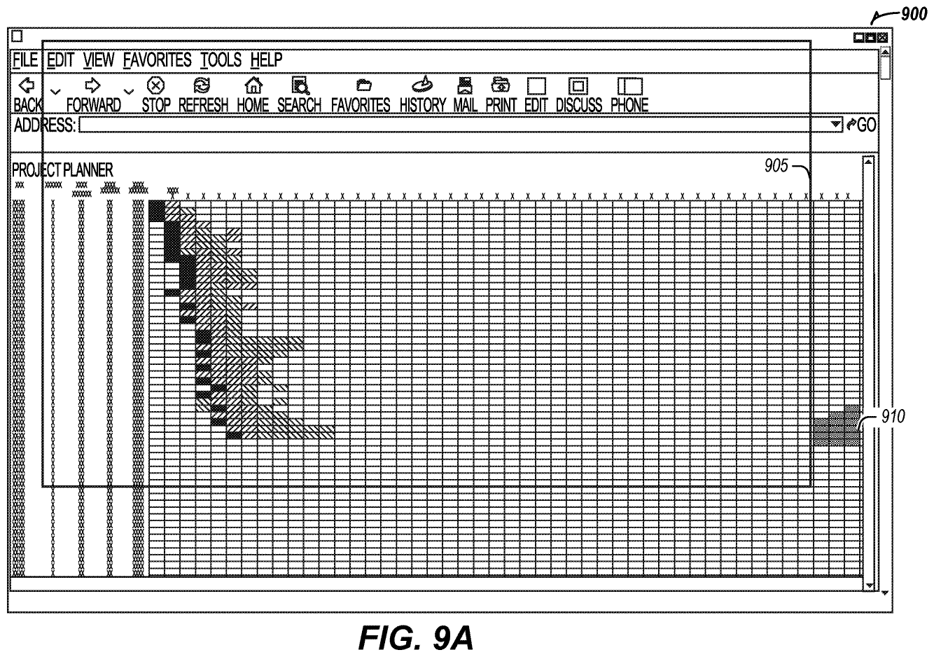

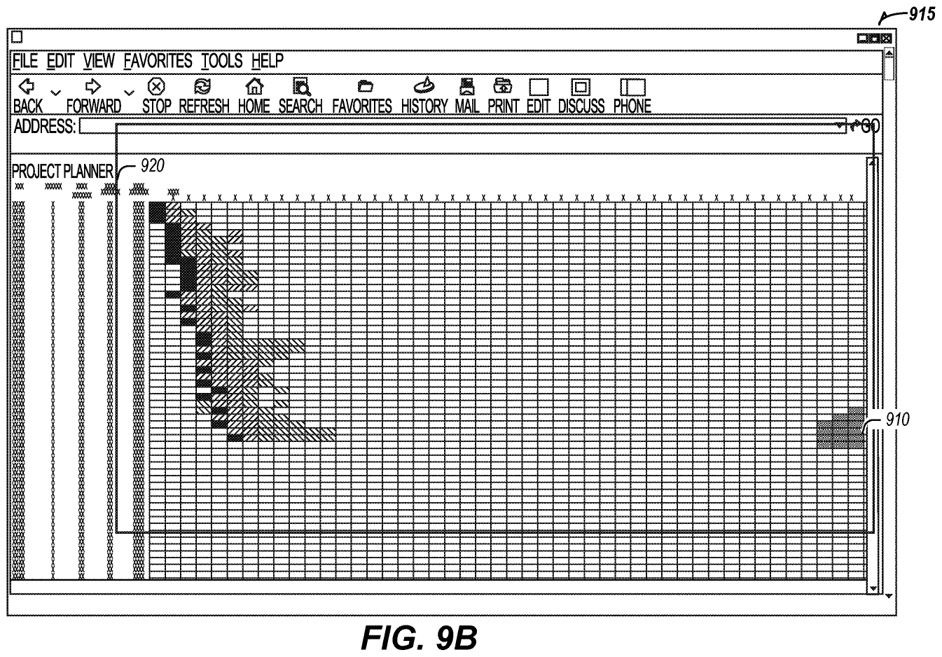

FIG. 9A, illustrates application of a conventional edge dimming boundary 905 based on conventional static dimming 900 for a spreadsheet window. The conventional edge dimming boundary 905 dims selected cells 910 of the spreadsheet window obscuring a view of a user. FIG. 9B illustrates application of an adaptive dimming boundary 920 calculated using adaptive edge dimming 915 to the spreadsheet window rather than the conventional edge dimming boundary 905 as shown in FIG. 9A. As shown in FIG. 9B, application of the adaptive edge dimming boundary 920 prevents dimming of the selected cells 910 of the spreadsheet window while dimming edges where there is no activity present.

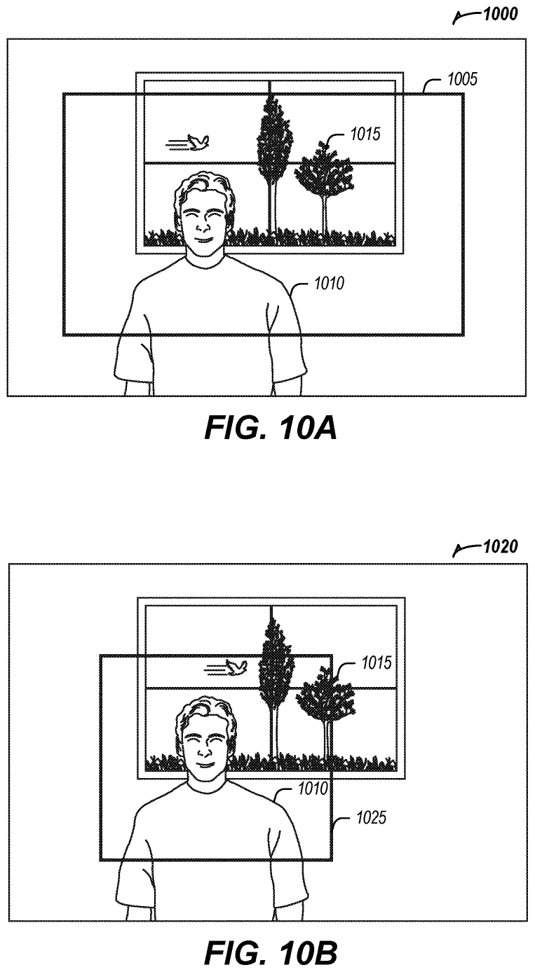

FIG. 10A illustrates an example of a conventional dimming edge boundary 1005 applied to a video conference window using conventional static edge dimming 1000. In FIG. 10A, the conventional dimming edge boundary 1005 prevents dimming of a speaker 1010 and a background object 1015. FIG. 10B illustrates application of an adaptive edge dimming boundary 1025 calculated using adaptive edge dimming 1020 for the video conference window rather than the conventional edge dimming boundary 1005 as shown in FIG. 10A. As shown in FIG. 10B, application of the adaptive edge dimming boundary 1025 dims the background object 1015 outside the adaptive edge dimming boundary while preserving the speaker 1010 within bounding box to prevent dimming of the speaker 1010. By adaptively calculating an edge dimming boundary, more aggressive power savings are achieved as compared to conventional fixed edge dimming shown in FIG. 10A.

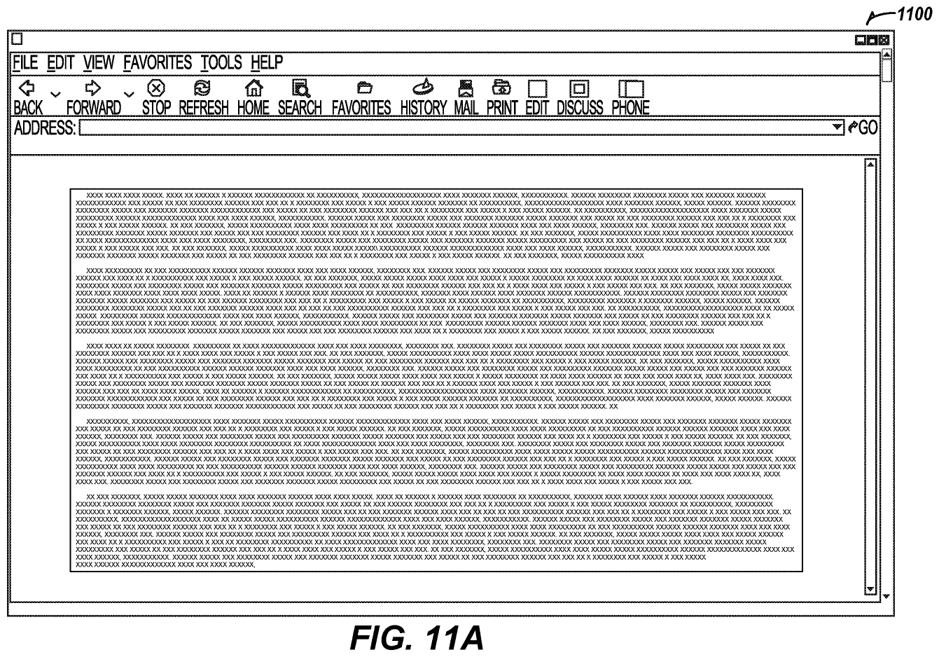

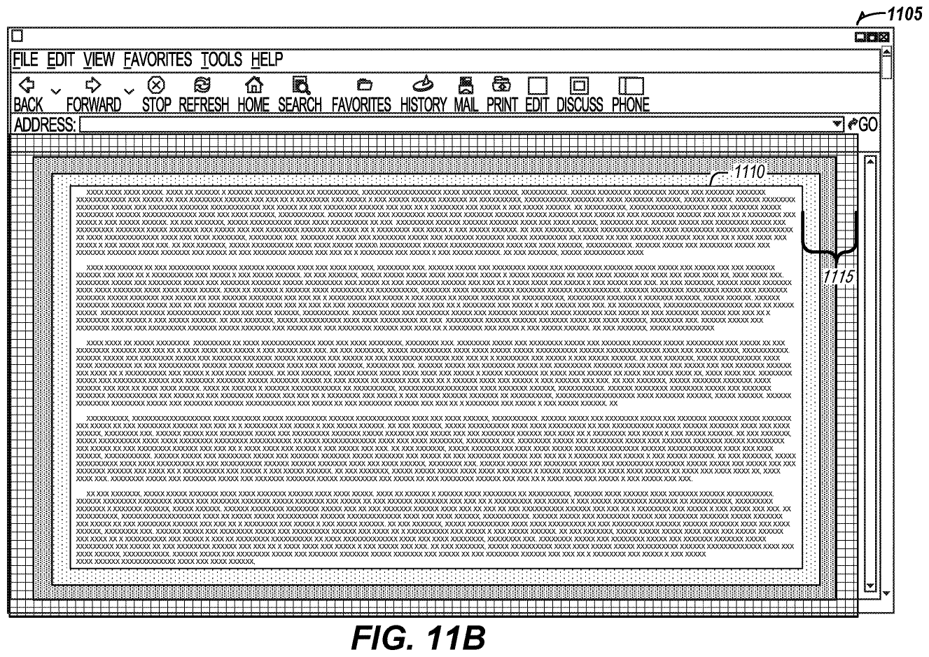

FIG. 11B illustrates an example of adaptive edge dimming applied 1105 to an original undimmed frame 1100 shown in FIG. 11A. The power consumption of the display measures three watts (shown at the bottom right corner). Most white pixels are dimmed 1115 resulting in up to 15% power savings and minimal visual change. A rectangular region is present where no dimming is applied called an Area of Interest (AOI) 1110. In an example, the amount of dimming applied to pixels is proportional to the distance of a pixel from the center of the AOI 1110. Pixels closer to the edge of the AOI 110 boundary will have less dimming applied while pixels closer to the edge of the display will have more dimming applied.

As shown in FIG. 11B, there is little visual impact, and no artifacts are introduced in the AOI 1110. The dimming algorithm is based on distance of pixels outside the AOI 1110 from the center of the AOI 1110. The size of the AOI 1110 may be controlled by the user by a factor call dimmed edge thickness percentage denoted by δ_{dep} which has a variable range (e.g., between [0,0.5]). For example, for a 1920×1080 resolution display δ_{dep}=0.01 means the rectangle will have

$$1920 \times \frac{{δ}_{dep}}{2} = 96$$

pixels on the left and right vertical edges of the screen and

$$1080 \times \frac{{δ}_{dep}}{2} = 54$$

on the top and bottom edges of the screen.

Adaptive edge dimming provides a consistent and enhanced user experience by dynamically adjusting edge dimming based on usage scenarios eliminating visual artifacts and perceived display defects. Adaptive edge dimming enables smooth transition to dimming rather than a sudden change introduced by conventional edge dimming solutions. Dimming strength and shape/position of the AOI 1110 are programmable and may be adapted to a usage scenario automatically. A proper size, position of the AOI 1110, and dimming strength are automatically adjusted based on the display usage scenario. For example, adaptive edge dimming may alter AOI 1110 parameters based on detected position of a human in the frame of a video conference, based on a pointer/cursor location on the display while working on a productivity application, etc. The dynamic nature of adaptive edge dimming enables uniform implementation across different vendors to reduce validation efforts.

Adaptive edge dimming, because it is dynamic, may provide more power saving opportunity compared to conventional static edge dimming. For a typical OLED display that consumes one watt of power to display a frame with a moderate On Pixel Ratio, the delta between conventional static edge dimming and adaptive edge dimming may be greater than 100 milliwatts.

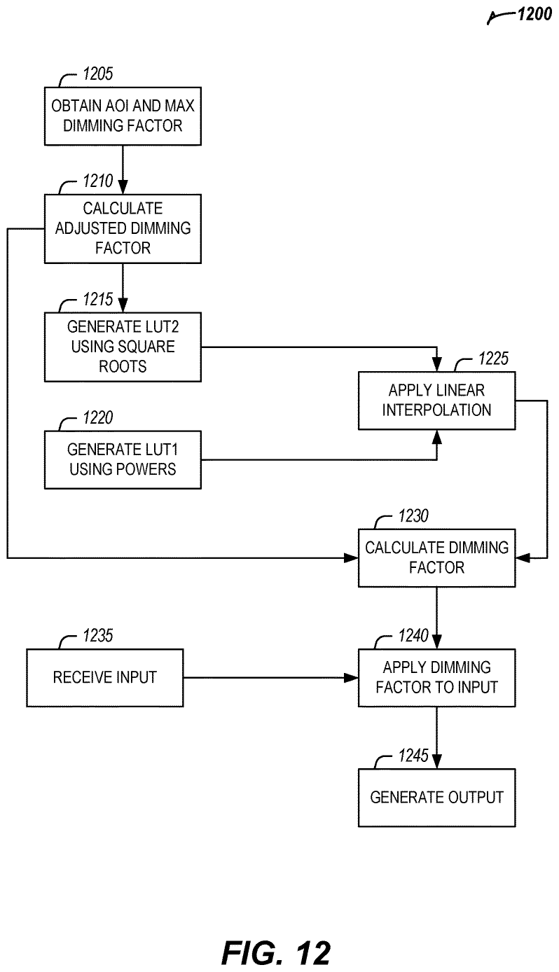

FIG. 12 is a flow chart of an example of a process 1200 for adaptive edge dimming, according to an embodiment. The process 1200 may provide features as described in FIGS. 1 to 11.

At operation 1205, an AOI and a maximum dimming factor are received (e.g., from the AIO detector 115 and the dimming factor manager 120, respectively, by the temporal phase-in generator 125 as described in FIG. 1, etc.)

At operation 1210, an adjusted dimming factor is calculated (e.g., by the temporal phase-in generator 125 using the AOI provided by the AOI detector 115, and the maximum dimming factor provided by the dimming factor manager 120, etc.). At operation 1215, A LUT is generated using square roots for pixel distances for a display (e.g., the LUT2 155 as described in FIG. 1, etc.).

At operation 1220, A LUT is generated using an exponent applied to pixel distances for a display (e.g., the LUT1 140 as described in FIG. 1, etc.). At operation 1225, linear interpolation is applied to the LUT generated at operation 1215 (e.g., by linear interpolation 160B as described in FIG. 1, etc.) and to the LUT generated at operation 1220 (e.g., by linear interpolation 160A as described in FIG. 1, etc.).

At operation 1230, a dimming factor is calculated (e.g., by display hardware 110 as described in FIG. 1, etc.) for a pixel of the display using the output of the linear interpolation from operation 1225 and the adjusted dimming factor. At operation 1235, display input is received (e.g., RGB signals, etc.). At operation 1240, the dimming factor is applied to the pixel (e.g., the dimming factor 165 as described in FIG. 1, etc.).

At operation 1245, output of the pixel is generated along with other pixels of the display adjusting the input as designated by the dimming factor. For example, if the pixel is within an AOI, the generated output may not include dimming and if the pixel is outside the AOI, it will have dimming applied as indicated by the dimming factor and at a rate determined using the adjusted dimming factor and distance from the center of the AOI.

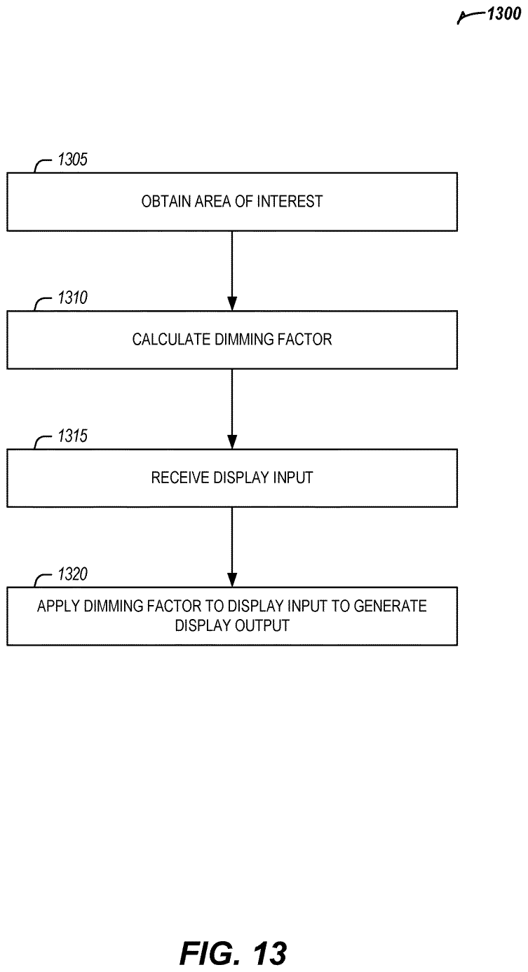

FIG. 13 is a flow chart of an example of a method 1300 for adaptive edge dimming, according to an embodiment. The method 1300 may provide features as described in FIGS. 1 to 12.

An area of interest is identified (e.g., by the AOI detector 115 as described in FIG. 1, etc.) for pixels displayed on the display (e.g., at operation 1305). A dimming factor is calculated (e.g., by the temporal phase-in generator 125 using the maximum dimming factor as described in FIG. 1, etc.) for a pixel of the pixels based on a distance of the pixel from a center of the area of interest (e.g., at operation 1310). In an example, the dimming factor may be calculated by applying a temporal filter to a maximum dimming factor. In an example, the dimming factor may be calculated by applying linear interpolation to a look up table generated by applying a power exponent value (e.g., γ) to a set of distances. In an example, the dimming factor may be calculated by applying linear interpolation to square root stored value for the pixel. In an example, the dimming factor may be calculated by applying linear interpolation to a look up table generated by calculating a square root for a set of distances. In an example, the area of interest may be a rectangle with small, rounded corners and the distance from the center may be calculated using an edge of a corner of the area of interest when the pixel is in a diagonal plane of the area of interest.

Display input is received (e.g., by hardware 110 as described in FIG. 1, etc.) to be output on the display (e.g., at operation 1315). Display output is generated (e.g., by the hardware using the dimming factor 165 as described in FIG. 1, etc.) by applying the dimming factor to the display input (e.g., at operation 1320). In an example, the pixel is dimmed based on application of the dimming factor to the pixel. In an example, an iteration value may be calculated for transition from a current power value of the pixel to a target power value for the pixel. A beta value may be determined for the transition and the dimming factor may be applied to the pixel in a series of iterations equal to the iteration value at a rate determined based on the beta value. In an example, pixels within the area of interest may not be dimmed and pixels outside the area of interest may be dimmed proportionally to their distance from the center of the area of interest.

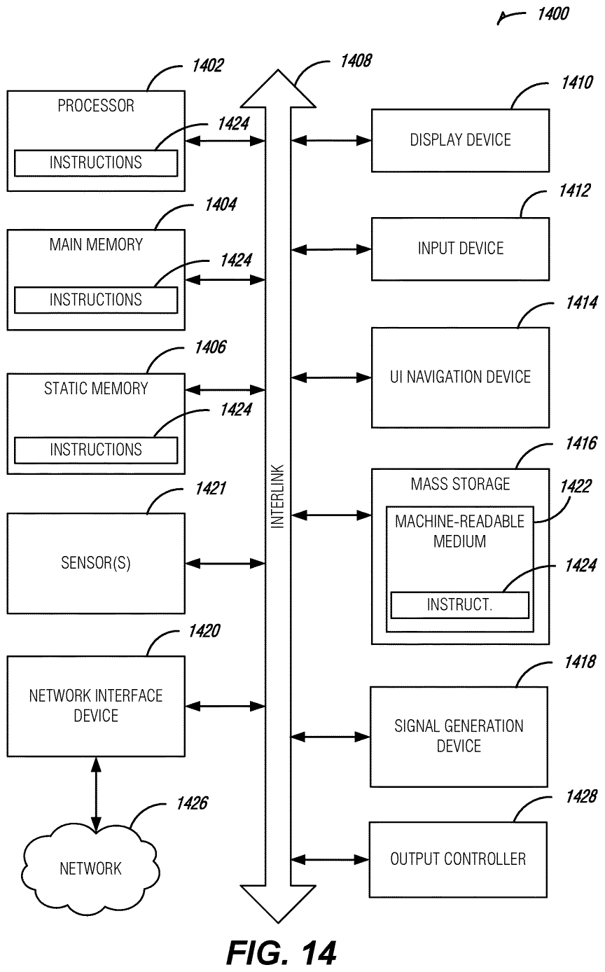

FIG. 14 illustrates a block diagram of an example machine 1400 upon which any one or more of the techniques (e.g., methodologies) discussed herein may perform. In alternative embodiments, the machine 1400 may operate as a standalone device or may be connected (e.g., networked) to other machines. In a networked deployment, the machine 1400 may operate in the capacity of a server machine, a client machine, or both in server-client network environments. In an example, the machine 1400 may act as a peer machine in peer-to-peer (P2P) (or other distributed) network environment. The machine 1400 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 1400 may include a hardware processor 1402 (e.g., a central processing unit (CPU), a graphics processing unit (GPU), a hardware processor core, or any combination thereof), a main memory 1404 and a static memory 1406, some or all of which may communicate with each other via an interlink (e.g., bus) 1408. The machine 1400 may further include a display unit 1410, an alphanumeric input device 1412 (e.g., a keyboard), and a user interface (UI) navigation device 1414 (e.g., a mouse). In an example, the display unit 1410, input device 1412 and UI navigation device 1414 may be a touch screen display. The machine 1400 may additionally include a storage device (e.g., drive unit) 1416, a signal generation device 1418 (e.g., a speaker), a network interface device 1420, and one or more sensors 1421, such as a global positioning system (GPS) sensor, compass, accelerometer, or other sensors. The machine 1400 may include an output controller 1428, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1416 may include a machine readable medium 1422 on which is stored one or more sets of data structures or instructions 1424 (e.g., software) embodying or utilized by any one or more of the techniques or functions described herein. The instructions 1424 may also reside, completely or at least partially, within the main memory 1404, within static memory 1406, or within the hardware processor 1402 during execution thereof by the machine 1400. In an example, one or any combination of the hardware processor 1402, the main memory 1404, the static memory 1406, or the storage device 1416 may constitute machine readable media.

While the machine readable medium 1422 is illustrated as a single medium, the term “machine readable medium” may include a single medium or multiple media (e.g., a centralized or distributed database, and/or associated caches and servers) configured to store the one or more instructions 1424.

The term “machine readable medium” may include any medium that is capable of storing, encoding, or carrying instructions for execution by the machine 1400 and that cause the machine 1400 to perform any one or more of the techniques of the present disclosure, or that is capable of storing, encoding or carrying data structures used by or associated with such instructions. Non-limiting machine-readable medium examples may include solid-state memories, and optical and magnetic media. In an example, machine readable media may exclude transitory propagating signals (e.g., non-transitory machine-readable storage media). Specific examples of non-transitory machine-readable storage media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1424 may further be transmitted or received over a communications network 1426 using a transmission medium via the network interface device 1420 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, LoRa®/LoRaWAN® LPWAN standards, etc.), IEEE 802.15.4 family of standards, peer-to-peer (P2P) networks, 3^{rd} Generation Partnership Project (3GPP) standards for 4G and 5G wireless communication including: 3GPP Long-Term evolution (LTE) family of standards, 3GPP LTE Advanced family of standards, 3GPP LTE Advanced Pro family of standards, 3GPP New Radio (NR) family of standards, among others. In an example, the network interface device 1420 may include one or more physical jacks (e.g., Ethernet, coaxial, or phone jacks) or one or more antennas to connect to the communications network 1426. In an example, the network interface device 1420 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1400, and includes digital or analog communications signals or other intangible medium to facilitate communication of such software.

### ADDITIONAL NOTES & EXAMPLES

Example 1 is an apparatus for adaptive edge dimming of a display comprising: at least one processor; and memory comprising instructions that, when executed by the at least one processor, cause the at least one processor to perform operations to: obtain an area of interest for pixels displayed on the display; calculate a dimming factor for a pixel of the pixels based on a distance of the pixel from a center of the area of interest; receive display input to be output on the display; and generate display output by applying the dimming factor to the display input.

In Example 2, the subject matter of Example 1 wherein, the dimming factor is calculated by applying a temporal filter to a maximum dimming factor.

In Example 3, the subject matter of Examples 1-2 wherein, the dimming factor is calculated by applying linear interpolation to a look up table generated by applying a power exponent value to a set of distances.

In Example 4, the subject matter of Examples 1-3 wherein, the dimming factor is calculated by applying linear interpolation to a square root stored value for the pixel.

In Example 5, the subject matter of Examples 1-4 wherein, the pixel is dimmed based on application of the dimming factor to the pixel.

In Example 6, the subject matter of Examples 1-5 includes, the memory further comprising instructions that, when executed by the at least one processor, cause the at least one processor to perform operations to: calculate an iteration value for transition from a current power value of the pixel to a target power value for the pixel; determine a beta value for the transition; and apply the dimming factor to the pixel in a series of iterations equal to the iteration value at a rate determined based on the beta value.

In Example 7, the subject matter of Examples 1-6 wherein, pixels within the area of interest are not dimmed and pixels outside the area of interest are dimmed proportionally to their distance from the center of the area of interest.

In Example 8, the subject matter of Examples 1-7 wherein, the area of interest is a rectangle with small, rounded corners and the distance from the center is calculated using an edge of a corner of the area of interest when the pixel is in a diagonal plane of the area of interest.

Example 9 is at least one non-transitory machine-readable medium comprising instructions for adaptive edge dimming of a display that, when executed by at least one processor, cause the at least one processor to perform operations to: obtain an area of interest for pixels displayed on the display; calculate a dimming factor for a pixel of the pixels based on a distance of the pixel from a center of the area of interest; receive display input to be output on the display; and generate display output by applying the dimming factor to the display input.

In Example 10, the subject matter of Example 9 wherein, the dimming factor is calculated by applying a temporal filter to a maximum dimming factor.

In Example 11, the subject matter of Examples 9-10 wherein, the dimming factor is calculated by applying linear interpolation to a look up table generated by applying a power exponent value to a set of distances.

In Example 12, the subject matter of Examples 9-11 wherein, the dimming factor is calculated by applying linear interpolation to a square root stored value for the pixel.

In Example 13, the subject matter of Examples 9-12 wherein, the pixel is dimmed based on application of the dimming factor to the pixel.

In Example 14, the subject matter of Examples 9-13 includes, instructions that, when executed by the at least one processor, cause the at least one processor to perform operations to: calculate an iteration value for transition from a current power value of the pixel to a target power value for the pixel; determine a beta value for the transition; and apply the dimming factor to the pixel in a series of iterations equal to the iteration value at a rate determined based on the beta value.

In Example 15, the subject matter of Examples 9-14 wherein, pixels within the area of interest are not dimmed and pixels outside the area of interest are dimmed proportionally to their distance from the center of the area of interest.

In Example 16, the subject matter of Examples 9-15 wherein, the area of interest is a rectangle with small, rounded corners and the distance from the center is calculated using an edge of a corner of the area of interest when the pixel is in a diagonal plane of the area of interest.

Example 17 is a method for adaptive edge dimming of a display comprising: obtaining an area of interest for pixels displayed on the display; calculating a dimming factor for a pixel of the pixels based on a distance of the pixel from a center of the area of interest; receiving display input to be output on the display; and generating display output by applying the dimming factor to the display input.

In Example 18, the subject matter of Example 17 wherein, the dimming factor is calculated by applying a temporal filter to a maximum dimming factor.

In Example 19, the subject matter of Examples 17-18 wherein, the dimming factor is calculated by applying linear interpolation to a look up table generated by applying a power exponent value to a set of distances.

In Example 20, the subject matter of Examples 17-19 wherein, the dimming factor is calculated by applying linear interpolation to a square root stored value for the pixel.

In Example 21, the subject matter of Examples 17-20 wherein, the pixel is dimmed based on application of the dimming factor to the pixel.

In Example 22, the subject matter of Examples 17-21 includes, calculating an iteration value for transition from a current power value of the pixel to a target power value for the pixel; determining a beta value for the transition; and applying the dimming factor to the pixel in a series of iterations equal to the iteration value at a rate determined based on the beta value.

In Example 23, the subject matter of Examples 17-22 wherein, pixels within the area of interest are not dimmed and pixels outside the area of interest are dimmed proportionally to their distance from the center of the area of interest.

In Example 24, the subject matter of Examples 17-23 wherein, the area of interest is a rectangle with small, rounded corners and the distance from the center is calculated using an edge of a corner of the area of interest when the pixel is in a diagonal plane of the area of interest.

Example 25 is at least one machine-readable medium including instructions that, when executed by a machine, cause the machine to perform any method of Examples 17-24.

Example 26 is a system comprising means to perform any method of Examples 17-24.

Example 27 is a system for adaptive edge dimming of a display comprising: means for obtaining an area of interest for pixels displayed on the display; means for calculating a dimming factor for a pixel of the pixels based on a distance of the pixel from a center of the area of interest; means for receiving display input to be output on the display; and means for generating display output by applying the dimming factor to the display input.

In Example 28, the subject matter of Example 27 wherein, the dimming factor is calculated by applying a temporal filter to a maximum dimming factor.

In Example 29, the subject matter of Examples 27-28 wherein, the dimming factor is calculated by applying linear interpolation to a look up table generated by applying a power exponent value to a set of distances.

In Example 30, the subject matter of Examples 27-29 wherein, the dimming factor is calculated by applying linear interpolation to a square root stored value for the pixel.

In Example 31, the subject matter of Examples 27-30 wherein, the pixel is dimmed based on application of the dimming factor to the pixel.

In Example 32, the subject matter of Examples 27-31 includes, means for calculating an iteration value for transition from a current power value of the pixel to a target power value for the pixel; means for determining a beta value for the transition; and means for applying the dimming factor to the pixel in a series of iterations equal to the iteration value at a rate determined based on the beta value.

In Example 33, the subject matter of Examples 27-32 wherein, pixels within the area of interest are not dimmed and pixels outside the area of interest are dimmed proportionally to their distance from the center of the area of interest.

In Example 34, the subject matter of Examples 27-33 wherein, the area of interest is a rectangle with small, rounded corners and the distance from the center is calculated using an edge of a corner of the area of interest when the pixel is in a diagonal plane of the area of interest.

Example 35 is at least one machine-readable medium including instructions that, when executed by processing circuitry, cause the processing circuitry to perform operations to implement of any of Examples 1-34.

Example 36 is an apparatus comprising means to implement of any of Examples 1-34.

Example 37 is a system to implement of any of Examples 1-34.

Example 38 is a method to implement of any of Examples 1-34.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. An apparatus for adaptive edge dimming of a display comprising:
at least one processor; and
memory comprising instructions that, when executed by the at least one processor, cause the at least one processor to perform operations to:
identify an area of interest for pixels displayed on the display;
calculate a dimming factor for a pixel of the displayed pixels based on a distance of the pixel from a center of the area of interest;
receive display input to be output on the display; and
generate display output by applying the dimming factor to the display input.

2. The apparatus of claim 1, wherein the dimming factor is calculated by applying a temporal filter to a maximum dimming factor.

3. The apparatus of claim 1, wherein the dimming factor is calculated by applying linear interpolation to a look up table generated by applying a power exponent value to a set of distances.

4. The apparatus of claim 1, wherein the dimming factor is calculated by applying linear interpolation to a square root stored value for the pixel.

5. The apparatus of claim 1, wherein the pixel is dimmed based on application of the dimming factor to the pixel.

6. The apparatus of claim 1, the memory further comprising instructions that, when executed by the at least one processor, cause the at least one processor to perform operations to:
calculate an iteration value for transition from a current power value of the pixel to a target power value for the pixel;
determine a beta value for the transition; and
apply the dimming factor to the pixel in a series of iterations equal to the iteration value at a rate determined based on the beta value.

7. The apparatus of claim 1, wherein pixels within the area of interest are not dimmed and pixels outside the area of interest are dimmed proportionally to their distance from the center of the area of interest.

8. The apparatus of claim 1, wherein the area of interest is a rectangle with rounded corners and the distance from the center is calculated using an edge of a corner of the area of interest when the pixel is in a diagonal plane of the area of interest.

9. At least one non-transitory machine-readable medium comprising instructions for adaptive edge dimming of a display that, when executed by at least one processor, cause the at least one processor to perform operations to:
identify an area of interest for pixels displayed on the display;
calculate a dimming factor for a pixel of the pixels based on a distance of the pixel from a center of the area of interest;
receive display input to be output on the display; and
generate display output by applying the dimming factor to the display input.

10. The at least one non-transitory machine-readable medium of claim 9, wherein the dimming factor is calculated by applying a temporal filter to a maximum dimming factor.

11. The at least one non-transitory machine-readable medium of claim 9, wherein the dimming factor is calculated by applying linear interpolation to a look up table generated by applying a power exponent value to a set of distances.

12. The at least one non-transitory machine-readable medium of claim 9, wherein the dimming factor is calculated by applying linear interpolation to square root stored value for the pixel.

13. The at least one non-transitory machine-readable medium of claim 9, wherein the pixel is dimmed based on application of the dimming factor to the pixel.

14. The at least one non-transitory machine-readable medium of claim 9, further comprising instructions that, when executed by the at least one processor, cause the at least one processor to perform operations to:
calculate an iteration value for transition from a current power value of the pixel to a target power value for the pixel;
determine a beta value for the transition; and
apply the dimming factor to the pixel in a series of iterations equal to the iteration value at a rate determined based on the beta value.

15. A system for adaptive edge dimming of a display comprising:
means for identifying an area of interest for pixels displayed on the display;
means for calculating a dimming factor for a pixel of the pixels based on a distance of the pixel from a center of the area of interest;
means for receiving display input to be output on the display; and
means for generating display output by applying the dimming factor to the display input.

16. The system of claim 15, wherein the dimming factor is calculated by applying a temporal filter to a maximum dimming factor.

17. The system of claim 15, wherein the dimming factor is calculated by applying linear interpolation to a look up table generated by applying a power exponent value to a set of distances.

18. The system of claim 15, wherein the dimming factor is calculated by applying linear interpolation to a square root stored value for the pixel.

19. The system of claim 15, wherein the pixel is dimmed based on the means for applying the dimming factor to the pixel.

20. The system of claim 15, further comprising:
means for calculating an iteration value for transition from a current power value of the pixel to a target power value for the pixel;
means for determining a beta value for the transition; and
means for applying the dimming factor to the pixel in a series of iterations equal to the iteration value at a rate determined based on the beta value.
